(19) United States
(12) Patent Application Publication
(10) Pub. No.: US 2025/0148581 A1
(43) Pub. Date: May 8, 2025

(54) IMAGE PROCESSING METHOD AND APPARATUS, AND DEVICE AND STORAGE MEDIUM

(71) Applicant: Beijing Zitiao Network Technology Co., Ltd., Haidian District, Beijing (CN)

(72) Inventors: Yongsheng Dong, Beijing (CN); Jing Huai, Beijing (CN); Jiajia Luo, Beijing (CN); Wenwen Fan, Beijing (CN)

(21) Appl. No.: 18/833,844

(22) PCT Filed: Jan. 17, 2023
(86) PCT No.: PCT/CN2023/072536

§ 371 Date: Jul. 26, 2024

(30) Foreign Application Priority Data
Jan. 28, 2022 (CN) 202210107876.0

(51) Int. Cl. G06T 5/77; G06T 5/50; G06T 7/00; G06T 7/11; G06T 7/13

(52) U.S. Cl. CPC G06T 5/77; G06T 5/50; G06T 7/0002; G06T 7/11; G06T 7/13; G06T 2207/20192; G06T 2207/20221; G06T 2207/30201

(57) ABSTRACT

Disclosed in embodiments of the disclosure are a method and apparatus for image processing, a device, and a storage medium. The method includes: performing skin segmentation on an original image, thereby obtaining a segmentation result image; fusing the segmentation result image and a standard facial-feature mask image, thereby obtaining a first skin region image; determining a blemish region according to the first skin region image and the original image; and adjusting a pixel of the blemish region in the original image, thereby obtaining a target image.

### CROSS-REFERENCE TO RELATED APPLICATION(S)

The disclosure claims the right of priority to Chinese patent application No. 202210107876.0, filed to the Chinese Patent Office on Jan. 28, 2022, which is incorporated in its entirety herein by reference.

### FIELD

Embodiments of the disclosure relate to the technical field of image processing, and relate to, for example, a method and an apparatus for image processing, a device, and a storage medium.

### BACKGROUND

In related technologies, a facial blemish removal method implements facial blemish removal and skin texture smoothing by a size of a filter kernel. But since the method processes the face globally, the absence of details of the facial features and skin texture will be caused, and an obvious fake face will be produced.

### SUMMARY

Embodiments of the disclosure provide a method and an apparatus for image processing, a device, and a storage medium, which can implement blemish removal to a face image, and avoid missing details of facial features and skin texture, so as to improve the realism of the face image after the blemish removal.

In a first aspect, the embodiments of the disclosure provide a method of image processing, comprising:
performing skin segmentation on an original image, thereby obtaining a segmentation result image;
fusing the segmentation result image and a standard facial-feature mask image, thereby obtaining a first skin region image;
determining a blemish region according to the first skin region image and the original image; and
adjusting a pixel in the blemish region in the original image, thereby obtaining a target image.

In a second aspect, the embodiments of the disclosure further provide an apparatus for image processing, comprising:
a segmentation result image obtainment module, configured to perform skin segmentation on an original image, thereby obtaining a segmentation result image;
a first skin region image obtainment module, configured to fuse the segmentation result image and a standard facial-feature mask image, thereby obtaining a first skin region image;
a blemish region determination module, configured to determine a blemish region according to the first skin region image and the original image; and
a pixel adjustment module, configured to adjust a pixel of the blemish region in the original image, thereby obtaining a target image.

In a third aspect, the embodiments of the disclosure further provide an electronic device. The electronic device comprises:
a processing apparatus; and
a memory configured to store a program, where
when the program is executed by the processing apparatus, the processing apparatus implements the method of image processing according to the embodiments of the disclosure.

In a fourth aspect, the embodiments of the disclosure provide a computer-readable medium having stored thereon a computer program. The program, when executed by a processing apparatus, implements the method of image processing according to the embodiments of the disclosure.

### BRIEF DESCRIPTION OF THE DRAWINGS

FIG. 1 is a flowchart of a method of image processing according to an embodiment of the disclosure;

FIG. 2 is a schematic diagram of a standard facial-feature mask image in an embodiment of the disclosure;

FIG. 3 is a schematic diagram of a first skin region image in an embodiment of the disclosure;

FIG. 4 is a schematic diagram of a first processing result image in an embodiment of the disclosure;

FIG. 5 is a schematic diagram of a second processing result image in an embodiment of the disclosure;

FIG. 6 is a schematic structural diagram of an apparatus for image processing in an embodiment of the disclosure; and

FIG. 7 is a schematic structural diagram of an electronic device in an embodiment of the disclosure.

### DETAILED DESCRIPTION OF EMBODIMENTS

Embodiments of the disclosure are described below with reference to the drawings. Although some embodiments of the disclosure are shown in the drawings, it should be understood that the disclosure may be embodied in various forms. These embodiments are provided, such that the disclosure will be understood more thoroughly and completely. It should be understood that the drawings and embodiments of the disclosure are for illustrative purposes merely.

It should be understood that various steps recited in the method embodiments of the disclosure can be performed in different orders and/or in parallel. Furthermore, the method embodiments can include additional steps and/or omit to execute the illustrated steps.

As used herein, the term “comprise” or “include” and their variations are open-ended, that is, “comprise but not limited to” and “include but not limited to”. The term “based on” is “based at least in part on”. The term “an embodiment” means “at least one embodiment”. The term “another embodiment” means “at least one further embodiment”. The term “some embodiments” means “at least some embodiments”. Definitions for other terms are given in the description below.

It should be noted that concepts such as “first” and “second” mentioned in the disclosure are merely used to distinguish different apparatuses, modules or units.

It should be noted that the modification with “a”, “an” or “a plurality of” in the disclosure is intended to be illustrative and should be understood by those skilled in the art as “one or more” unless the context clearly dictates otherwise.

The names of messages or information exchanged between a plurality of apparatuses in the embodiments of the disclosure are merely for illustrative purposes.

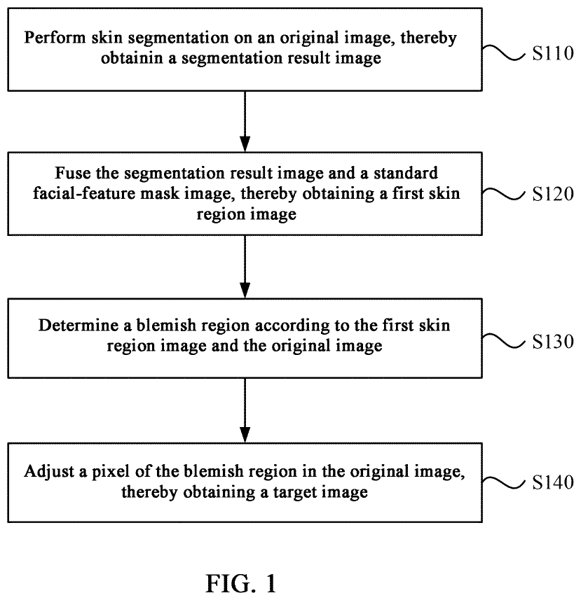

FIG. 1 is a flowchart of a method of image processing provided in an embodiment of the disclosure. The embodiment may be applicable to a case of skin blemish removal. The method may be executed by an apparatus for image processing. The apparatus may be composed of hardware and/or software, and may generally be integrated into a device having an image processing function. The device may be an electronic device such as a server, a mobile terminal, or a server cluster. As shown in FIG. 1, the method specifically includes:

S110, skin segmentation on an original image is performed, thereby obtaining a segmentation result image.

In the embodiment, the original image may be an image including a human skin region, for example, including a human face, human limbs, etc. In the embodiment, the original image is an image including a human face. That is, the embodiment mainly removes skin blemishes from the face.

Alternatively, a process of skin segmentation on the original image may be understood as a process of segmenting out regions that do not belong to a skin region (such as background) and regions that cover skin (such as clothes, hair, etc.). For an original image including a face, the segmentation result image is an image including the entire face (facial features+face+neck).

In the embodiment, any skin segmentation method in the related art may be used to perform skin segmentation on the original image. For example, a method of skin detection based on a color space+adaptive threshold segmentation, a method of skin detection based on an elliptical space+adaptive threshold method+portrait background removal, a method of image segmentation based on an elliptical space+image segmentation based on a hue saturation value (HSV) space, or an artificial intelligence (AI) model may be used. In the embodiment, performing skin segmentation on the original image may prevent a clothing region and a hair region in the original image from being processed.

S120, the segmentation result image and a standard facial-feature mask image are fused, thereby obtaining a first skin region image.

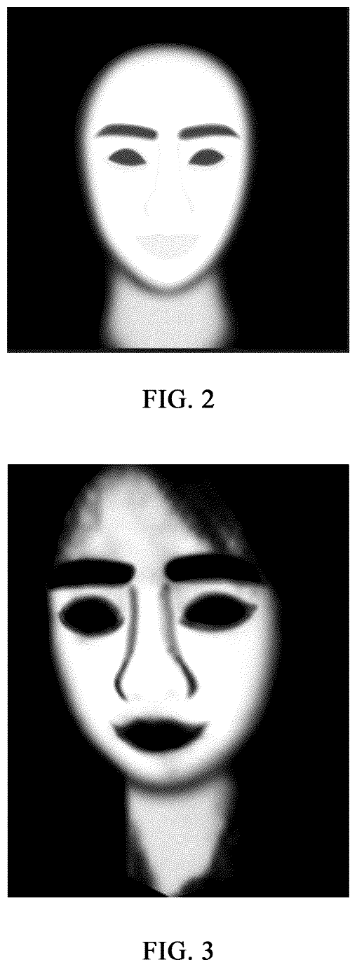

In the embodiment, the standard facial-feature mask image can be understood as a mask image covering facial features (eyebrows, eyes, nostrils and lips). The facial features in the embodiment are not five sense organs in a traditional sense, but include eyebrows, eyes, nostrils and lips, that is, the nostrils are masked instead of an entire nose since there is also a skin region on a nasal bridge. In this way, it is guaranteed that a blemish is also removed from the skin region on the nasal bridge. Illustratively, FIG. 2 is a schematic diagram of a standard facial-feature mask image in the embodiment. As shown in FIG. 2, in the mask diagram, facial-feature regions are covered, and other regions are not covered.

In the embodiment, a method for fusing the segmentation result image and a standard facial-feature mask image may include: taking an intersection of the segmentation result image and the standard facial-feature mask image, thereby obtaining the first skin region image.

In the embodiment, the first skin region image may be an image in which only a skin region remains in the segmentation result image, such that it is guaranteed that non-facial-skin regions such as eyebrows, hair, eyes, lips, nostrils, etc. are not influenced when subsequent operations are executed. Alternatively, a method for taking an intersection of the segmentation result image and the standard facial-feature mask image may include: multiplying a matrix corresponding to the segmentation result image by a matrix corresponding to the standard facial-feature mask image, thereby obtaining the first skin region image. Illustratively, FIG. 3 is a schematic diagram of the first skin region image in the embodiment. As shown in FIG. 3, the first skin region image is an image in which facial features such as eyebrows, eyes, nostrils, nasal bridge edges, and lips are covered in the segmentation result image.

Alternatively, after obtaining a first skin region image, the method further includes: performing set filtering processing on the first skin region image.

In the embodiment, the set filtering processing may be bilateral filtering. A principle of bilateral filtering may be to use a convolution kernel for sliding window convolution calculation on the first skin region image. During bilateral filtering, in order to preserve an edge of the image, detection is needed according to neighborhoods of currently convolved pixels, to determine whether the currently convolved pixels are edge points and points close to the edge. In the case that the currently convolved pixels are edge points and the points close to the edge, an element in the convolution kernel is changed. In the case that the currently convolved pixels are not edge points and points close to the edge, convolution calculation is performed by using the original convolution kernel. In the embodiment, bilateral filtering is used for processing the first skin region image, which can make the first skin region image Gaussian fuzzy while guaranteeing that contours of the facial features (contours of the nose, the eyes and the lips) are more clear.

S130, a blemish region is determined according to the first skin region image and the original image.

In the embodiment, the blemish region may include a spot region, a pockmark region, and an acne region in the skin. In the embodiment, blemishes may be classified according to colors of the blemishes, such that blemishes of different categories can be identified separately.

Alternatively, determining a blemish region according to the first skin region image and the original image may include: extracting a skin region of the original image, thereby obtaining a second skin region image; and determining at least one of a first type blemish region and a second type blemish region according to the first skin region image and the second skin region image. Adjusting a pixel of the blemish region in the original image, thereby obtaining a target image may include: adjusting a pixel of at least one of the first type blemish region and the second type blemish region in the original image, thereby obtaining the target image.

In the embodiment, the first type blemish region may be a region including a blemish with a reddish color, such as red and swollen acne, etc. The second type blemish region may be a region with a dark color, such as dark spots, etc.

In the embodiment, the original image and the first skin region image have the same size. Pixel points in the original image correspond to pixel points in the first skin region image in a one-to-one manner, that is, pixels of the two images are aligned. A method for extracting the skin region of the original image may include: traversing the pixel points of the first skin region image; in the case that a pixel value of a traversed pixel point is greater than a set threshold, a pixel point corresponding to the pixel point in the original image is a skin pixel point; and in the case that a pixel value of a traversed pixel point is less than or equal to the set threshold, a pixel point corresponding to the pixel point in the original image is a non-skin pixel point; extracting the skin pixel point from the original image, thereby obtaining the second skin region image. Alternatively, a method for extracting the skin region of the original image may further include: taking an intersection of the original image and the standard facial-feature mask image, thereby obtaining a second skin region image.

In the embodiment, the blemishes in the original image may be removed according to the following steps: first, determining the first type blemish region according to the first skin region image and the second skin region image, and then adjusting pixels of the first type blemish region in the original image; and determining the second type blemish region according to the second skin region image from which a first type blemish is removed and the first skin region image, and then adjusting pixels of the second type blemish region in the original image from which the first type blemish is removed, thereby obtaining the target image. Alternatively, first, determining the second type blemish region according to the first skin region image and the second skin region image, and then adjusting pixels of the second type blemish region in the original image; and determining the first type blemish region according to the second skin region image from which a second type blemish is removed and the first skin region image, and then adjusting pixels of the first type blemish region in the original image from which the second type blemish is removed, thereby obtaining the target image. In the embodiment, the first type blemish and the second type blemish are removed from the original image separately, such that precision of blemish removal can be guaranteed.

Alternatively, a method for determining the first type blemish region according to the first skin region image and the original image may include: converting the first skin region image into a first skin color space Lab image; converting the second skin region image into a second skin Lab image; executing a high pass operation on a set space channel of the first skin Lab image and the second skin Lab image, thereby obtaining a first intermediate result image; executing at least one hard light operation on the first intermediate result image, thereby obtaining a first processing result image; and determining pixel points having a value of the set space channel greater than a first set threshold in the first processing result image as first type blemish points, and determining a region defined by the first type blemish points as the first type blemish region.

In the embodiment, both the first skin region image and the second skin region image are RGB images. Any manner in the related art may be used to convert the RGB images into Lab images. The set space channel may be a channel a. Since the channel a represents a green-red axis, reddish blemishes, such as red and swollen acne, in the image can be identified by processing the channel a. In the embodiment, values of three space channels in the Lab image are normalized, that is, the values of the three channels are all values between 0 and 1.

Alternatively, the method of executing a high pass operation on the set space channel of the first skin Lab image and the second skin Lab image may include: subtracting a value of the channel a of the second skin Lab image from a value of the channel a of the first skin Lab image, and taking the difference value as the value of the channel a of the first intermediate result image.

Executing at least one hard light operation on the first intermediate result image may be understood as executing at least one hard light operation on the channel a of the first intermediate result image. The hard light operation may be executed by adjusting the value of the channel a according to a set rule. Alternatively, the set rule may be that in a case that the value of the channel a is greater than a set value (for example, 0.5), the value of the channel a is adjusted according to the following formula: 2.0*a*a; and in a case that the value of the channel a is less than or equal to the set value (for example, 0.5), the value of the channel a is adjusted according to the following formula: 1−2*(1−a)*(1−a). In the embodiment, three to five hard light operations are executed on the first intermediate result images.

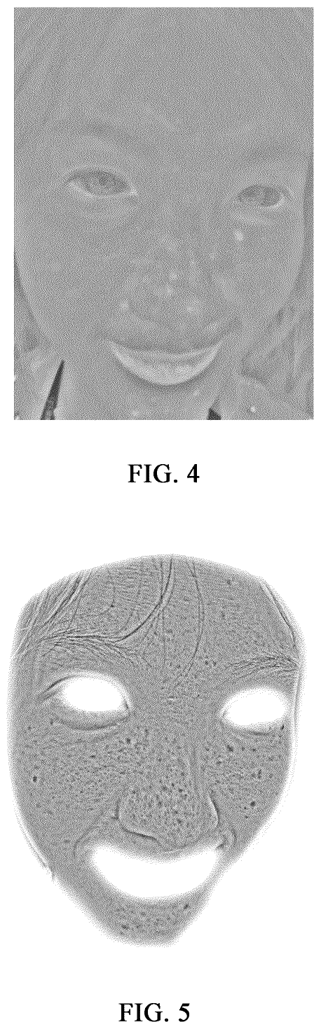

Alternatively, after the first processing result image is obtained, pixel points having a value of the set space channel greater than a first set threshold in the first processing result image are determined as first type blemish points, and a region defined by the first type blemish points is determined as the first type blemish region. The first set threshold may be set to be 0.8. Illustratively, FIG. 4 is a schematic diagram of the first processing result image in the embodiment. As shown in FIG. 4, for the first type blemish region, the color is white, that is, the value of the channel a is greater than the first set threshold. In the embodiment, the channel a in the Lab image is used to detect the first type blemish region, and the first type blemish region can be detected quickly.

Alternatively, a method of determining the second type blemish region according to the first skin region image and the original image may include: executing a high pass operation on a set color channel of the first skin region image and the second skin region image, thereby obtaining a second intermediate result image; executing at least one hard light operation on the second intermediate result image, thereby obtaining a second processing result image; and determining pixel points having a value of the set color channel less than a second set threshold in the second processing result image as second type blemish points, and determining a region defined by the second type blemish points as the second type blemish region.

In the embodiment, both the first skin region image and the second skin region image are RGB images. The second skin region may be a skin region image extracted from the original image, or a second skin region image with the first type blemish removed. A set color channel may be a blue (B) channel. Processing the B channel may identify dark-color blemishes, such as dark spots. In the embodiment, values of three color channels in the RGB image are normalized, that is, the values of the three channels are all values between 0 and 1.

Alternatively, the method of executing a high pass operation on the set color channel of the first skin region image and the second skin region image may include: subtracting a value of the B channel of the second skin region image from a value of the B channel of the first skin region image, and taking a difference value as a value of a B channel of the second intermediate result image.

Executing at least one hard light operation on the second intermediate result image may be understood as executing at least one hard light operation on the B channel of the second intermediate result image. The hard light operation may be executed by adjusting the value of the B channel according to a set rule. Alternatively, the set rule may be that in a case that the value of the B channel is greater than a set value (for example, 0.5), the value of the B channel is adjusted according to the following formula: 2.0*b*b; and in a case that the value of the B channel is less than or equal to the set value (for example, 0.5), the value of the B channel is adjusted according to the following formula: 1−2*(1−b)*(1−b). In the embodiment, one hard light operation is executed on the first intermediate result image.

Alternatively, after the second processing result image is obtained, pixel points having a value of the set color channel less than a second set threshold in the second processing result image are determined as second type blemish points, and a region defined by the second type blemish points is determined as the second type blemish region. The second set threshold may be set to be 0.45. Illustratively, FIG. 5 is a schematic diagram of the second processing result image in the embodiment. As shown in FIG. 5, for the first type blemish region, the color is dark, that is, the value of the B channel is smaller than the second set threshold. In the embodiment, the B channel in the RGB image is used to detect the second type blemish region, and the second type blemish region can be detected quickly.

S140, a pixel of the blemish region in the original image is adjusted, thereby obtaining a target image

In the embodiment, since the pixels of the first skin region image and the pixels of the original image are aligned, after a blemish region is obtained from the first skin region image, the position of the blemish region in the original image can be determined. Similarly, since the pixels of the first processing result image and the pixels of the original image are aligned, after a first type blemish region is determined in the first processing result image, the position of the first type blemish region in the original image can be determined. Since the pixels of the second processing result image and the pixels of the original image are aligned, after a second type blemish region is determined in the second processing result image, the position of the second type blemish region in the original image can be determined.

Alternatively, for the first type blemish region, the method of adjusting a pixel of the first type blemish region in the original image may include: adjusting at least one of hue, brightness, and saturation of the first type blemish region in the original image.

In the embodiment, average values of hue, brightness and saturation of all pixels in a non-blemish region in the original image may be calculated, and then the hue, the brightness and the saturation of the first type blemish region may be adjusted to the corresponding average values; and alternatively, at least one of the hue, the brightness and the saturation of the first type blemish region is adjusted to a set value. The set value may be a value determined according to non-blemish skin. In the embodiment, at least one of the hue, the brightness and the saturation of the first type blemish region in the original image is adjusted, such that the first type blemish region is adjusted to normal skin color, such that an effect of beautifying skin is achieved.

Alternatively, for the second type blemish region, the method of adjusting a pixel of the second type blemish region in the original image may include: adjusting a color value of the second type blemish region in the original image.

In the embodiment, an average color value of all pixels in the non-blemish region in the original image may be calculated, and then the color value of the second type blemish region may be adjusted to the corresponding average value; and alternatively, color may be adjusted using a look-up table. The color value of the second type blemish region in the original image is adjusted to restore the second type blemish region to a normal skin color, such that the effect of beautifying skin is achieved.

A method of image processing is disclosed in the embodiments of the disclosure. The method includes: performing skin segmentation on an original image, thereby obtaining a segmentation result image; fusing the segmentation result image and a standard facial-feature mask image, thereby obtaining a first skin region image; determining a blemish region according to the first skin region image and the original image; and adjusting a pixel of the blemish region in the original image, thereby obtaining a target image. According to the method of image processing provided by the embodiments of the disclosure, the blemish region is determined based on the first skin region image, which is obtained by fusing the segmentation result image and the standard facial-feature mask image, and the original image, to achieve the removal of a blemish region from the original image. In this way, missing details of facial features and skin texture can be avoided, and the realism of the face image after blemish removal is improved.

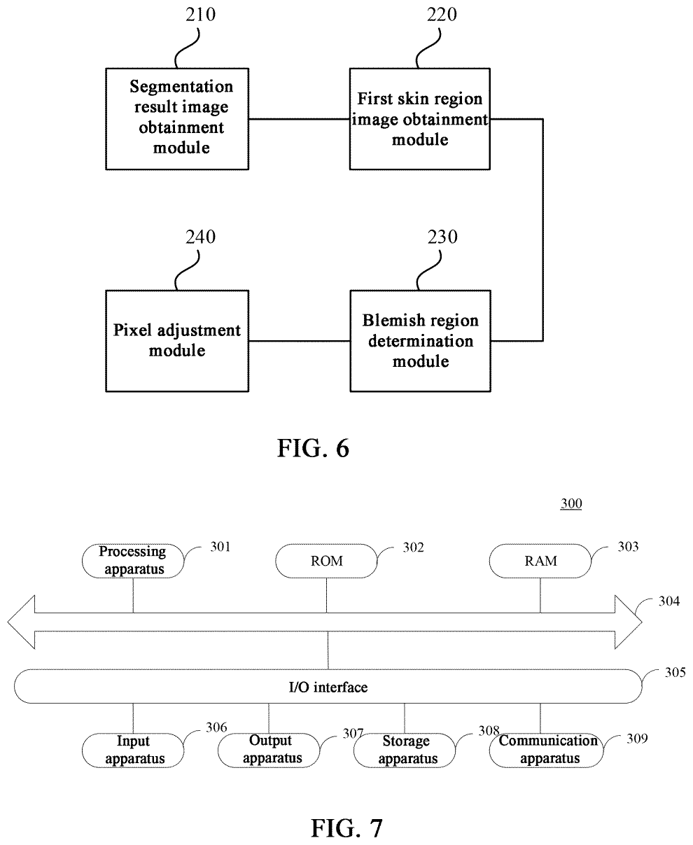

FIG. 6 is a schematic structural diagram of an apparatus for image processing according to an embodiment of the disclosure. As shown in FIG. 6, the apparatus includes:
a segmentation result image obtainment module 210 configured to perform skin segmentation on an original image, thereby obtaining a segmentation result image;
a first skin region image obtainment module 220 configured to fuse the segmentation result image and a standard facial-feature mask image, thereby obtaining a first skin region image;
a blemish region determination module 230 configured to determine a blemish region according to the first skin region image and the original image; and
a pixel adjustment module 240 configured to adjust a pixel of the blemish region in the original image, thereby obtaining a target image.

Alternatively, the first skin region image obtainment module 220 is configured to fuse the segmentation result image and the standard facial-feature mask image by the following, thereby obtaining the first skin region image:
taking an intersection of the segmentation result image and the standard facial-feature mask image, thereby obtaining the first skin region image.

Alternatively, the blemish region determination module 230 is configured to determine the blemish region according to the first skin region image and the original image by the following:
extracting a skin region of the original image, thereby obtaining a second skin region image; and
determining at least one of a first type blemish region and a second type blemish region according to the first skin region image and the second skin region image.

Alternatively, the pixel adjustment module 240 is configured to adjust the pixel of the blemish region in the original image by the following, thereby obtaining the target image:
adjusting a pixel of at least one of the first type blemish region and the second type blemish region in the original image, thereby obtaining the target image.

Alternatively, the blemish region determination module 230 is configured to determine the first type blemish region according to the first skin region image and the original image by the following:
converting the first skin region image into a first skin color space Lab image;
converting the second skin region image into a second skin Lab image;
executing a high pass operation on a set space channel of the first skin Lab image and the second skin Lab image, thereby obtaining a first intermediate result image;
executing at least one hard light operation on the first intermediate result image, thereby obtaining a first processing result image; and
determining pixel points having a value of the set space channel greater than a first set threshold in the first processing result image as first type blemish points, and determining a region defined by the first type blemish points as the first type blemish region.

Alternatively, the pixel adjustment module 240 is configured to adjust a pixel of the first type blemish region in the original image by the following:
adjusting at least one of hue, brightness, and saturation of the first type blemish region in the original image.

Alternatively, the blemish region determination module 230 is configured to determine the second type blemish region according to the first skin region image and the original image by the following:
executing a high pass operation on the set color channel of the first skin region image and the second skin region image, thereby obtaining a second intermediate result image;
executing at least one hard light operation on the second intermediate result image, thereby obtaining a second processing result image; and
determining pixel points having a value of the set color channel less than a second set threshold in the second processing result image as second type blemish points, and determining a region defined by the second type blemish points as the second type blemish region.

Alternatively, the pixel adjustment module 240 is configured to adjust a pixel of the second type blemish region in the original image by the following:
adjusting a color value of the second type blemish region in the original image.

Alternatively, the apparatus further includes a filtering module configured to:
perform set filtering on the first skin region image.

The apparatus can execute the methods provided in all embodiments of the disclosure, and has corresponding functional modules and beneficial effects for executing the methods. For technical details not described in detail in the embodiment, reference may be made to the methods provided in all of the embodiments of the disclosure.

With reference to FIG. 7 below, a schematic structural diagram of an electronic device 300 suitable for implementing an embodiment of the disclosure is shown. The electronic device in the embodiment of the disclosure may include mobile terminals such as mobile phones, notebook computers, digital broadcast receivers, personal digital assistants (PDAs), portable android devices (PADs), portable media players (PMP), in-vehicle terminals (for example, in-vehicle navigation terminals), etc., and fixed terminals such as digital televisions (TVs) desktop computers, etc., or various forms of servers, such as standalone servers or server clusters. The electronic device illustrated in FIG. 7 is merely an instance.

As shown in FIG. 7, the electronic device 300 may include a processing apparatus (for example, a central processing unit, a graphics processing unit, etc.) 301. The electronic device 300 may execute various appropriate actions and processes according to programs stored in a read-only memory (ROM) 302 or programs loaded from a memory 305 into a random-access memory (RAM) 303. The RAM 303 also stores various programs and data needed for the operations of the electronic device 300. The processing apparatus 301, the ROM 302, and the RAM 303 are connected to each other by means of a bus 304. An input/output (I/O) interface 305 is also connected to the bus 304.

Typically, the following apparatuses may be connected to the I/O interface 305: an input apparatus 306 including, for example, a touch screen, a touch pad, a keyboard, a mouse, a camera, a microphone, an accelerometer, a gyroscope, etc.; an output apparatus 307 including, for example, a liquid crystal display (LCD), a speaker, a vibrator, etc.; a storage apparatus 308 including, for example, a magnetic tape, a hard disk, etc.; and a communication apparatus 309. The communication apparatus 309 may allow the electronic device 300 to be in wireless or wired communication with other devices to exchange data. While the FIG. 7 illustrates an electronic device 300 having various apparatuses, it should be understood that not all of the illustrated apparatuses are required to be implemented or provided. More or fewer apparatuses may alternatively be implemented or provided.

In particular, according to embodiments of the disclosure, a processes described above with reference to the flowcharts may be implemented as a computer software program. For example, embodiments of the present disclosure include a computer program product. The computer program product includes a computer program carried on a computer-readable medium, and the computer program includes a program code for executing the method of word recommendation illustrated in the flowchart. In such embodiments, the computer program may be downloaded and installed from a network by means of the communication apparatuses 309, or installed from the storage device 305, or installed from the ROM 302. When executed by the processing apparatus 301, the computer program executes the above functions in the method of the embodiment of the disclosure.

It should be noted that the computer-readable medium in the disclosure may be a computer-readable signal medium or a computer-readable storage medium, or any combination of a computer-readable signal medium and a computer-readable storage medium. The computer-readable storage medium may include an electronic, magnetic, optical, electromagnetic, infrared, or semiconductor system, apparatus, or device, or any combination of the foregoing. The computer-readable storage medium may include an electrical connection based on one or more wires, a portable computer diskette, a hard disk, a random-access memory, a read-only memory, an erasable programmable read-only memory (EPROM or flash memory), an optical fiber, a portable compact disc read-only memory (CD-ROM), an optical storage device, a magnetic storage device, or any suitable combination of the foregoing. In the disclosure, the computer-readable storage medium may be any tangible medium that includes or stores a program for use by or in conjunction with an instruction execution system, apparatus, or device. In the disclosure, the compute-readable signal medium may include a data signal propagating in a baseband or as part of a carry wave and carrying a computer-readable program code. Such a propagated data signal may have a variety of forms and may include an electromagnetic signal, an optical signal, or any suitable combination of the foregoing. The computer-readable signal medium may also be any computer-readable medium except a computer-readable storage medium. The computer-readable signal medium can send, propagate, or transmit a program for use by or in conjunction with an instruction execution system, apparatus, or device. A program code included on a computer-readable medium may be transmitted by means of any suitable medium, including wires, fiber optic cables, radio frequency (RF), etc., or any suitable combination of the foregoing.

In some embodiments, a client and a server may communicate by using any currently known or future-developed network protocol, such as a hypertext transfer protocol (HTTP), and may be interconnected with any form or medium of digital data communication (for example, a communication network). Examples of communication networks include a local area network (LAN), a wide area network (WAN), Internet work (for example, the Internet), and an end-to-end network (for example, an ad hoc end-to-end network), as well as any currently known or future-developed network.

The computer-readable medium may be included in the above electronic device, and may also exist independently without being assembled into the electronic device.

The computer-readable medium carries one or more programs. The one or more programs, when executed by the electronic device, cause the electronic device to: perform skin segmentation on an original image, thereby obtaining a segmentation result image; fuse the segmentation result image and a standard facial-feature mask image, thereby obtaining a first skin region image; determine a blemish region according to the first skin region image and the original image; and adjust a pixel of the blemish region in the original image, thereby obtaining a target image.

A computer program code for performing operations of the disclosure may be written in one or more programming languages, or combinations of the programming languages. The programming languages include object-oriented programming languages, such as Java, Smalltalk, and C++, and further include conventional procedural programming languages, such as the C programming language or similar programming languages. The program code may be executed entirely on a user computer, partly on a user computer, as a stand-alone software package, partly on a user computer and partly on a remote computer, or entirely on a remote computer or server. In the case involving a remote computer, the remote computer may be connected to a user computer through any kind of network, including an LAN or a WAN, or may be connected to an external computer (for example, connected through the Internet by using an Internet service provider).

The flowcharts and block diagrams in the accompanying drawings illustrate the architecture, functionality, and operations possibly implemented by the systems, methods, and computer program products according to various embodiments of the disclosure. In this regard, each block in the flowcharts or block diagrams may represent a module, a program segment, or part of code, and a module, a program segment, or part of a code including one or more executable instructions for implementing a specified logical function. It should also be noted that in some alternative implementations, a function noted in a block may occur in a different order than an order noted in the figures. For example, two consecutive blocks may actually be executed substantially in parallel, or in a reverse order sometimes, depending on THE function involved. It should also be noted that each block in the block diagrams and/or flowcharts, and combinations of blocks in the block diagrams and/or flowcharts, can be implemented by special purpose hardware-based systems that perform specified functions or operations, or can be implemented by combinations of special purpose hardware and computer instructions.

The units described in the embodiment of the disclosure may be implemented in software or hardware. The name of a unit does not constitute a qualification of the unit itself under certain circumstances.

The functions described above herein may be executed at least partially by one or more hardware logic components, for example, exemplary types of hardware logic components that may be used include, field programmable gate arrays (FPGAs), application specific integrated circuits (ASICs), application specific standard parts (ASSPs), systems on chip (SOCs), complex programmable logic devices (CPLDs), etc.

In the context of the disclosure, the machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include an electronic, magnetic, optical, electromagnetic, infrared, or semiconductor system, apparatus, or device, or any suitable combination of the foregoing. The machine-readable storage medium may include an electrical connection based on one or more wires, a portable computer diskette, a hard disk, an RAM, an ROM, an erasable programmable read-only memory (EPROM or flash memory), an optical fiber, a CD-ROM, an optical storage device, a magnetic storage device, or any suitable combination of the foregoing.

According to one or more of the embodiments of the disclosure, a method of image processing is disclosed in the embodiments of the disclosure. The method includes:
performing skin segmentation on an original image, thereby obtaining a segmentation result image;
fusing the segmentation result image and a standard facial-feature mask image, thereby obtaining a first skin region image;
determine a blemish region according to the first skin region image and the original image; and
adjust a pixel of the blemish region in the original image, thereby obtaining a target image.

In an embodiment, fusing the segmentation result image and a standard facial-feature mask image, thereby obtaining a first skin region image, includes:
taking an intersection of the segmentation result image and the standard facial-feature mask image, thereby obtaining the first skin region image.

In an embodiment, determining a blemish region according to the first skin region image and the original image includes:
extracting a skin region of the original image, thereby obtaining a second skin region image; and
determining at least one of a first type blemish region and a second type blemish region according to the first skin region image and the second skin region image; and
adjusting a pixel of the blemish region in the original image, thereby obtaining a target image, includes:
adjusting a pixel of at least one of the first type blemish region and the second type blemish region in the original image, thereby obtaining the target image.

In an embodiment, determining the first type blemish region according to the first skin region image and the original image includes:
converting the first skin region image into a first skin color space Lab image;
converting the second skin region image into a second skin Lab image;
executing a high pass operation on a set space channel of the first skin Lab image and the second skin Lab image, thereby obtaining a first intermediate result image;
executing at least one hard light operation on the first intermediate result image, thereby obtaining a first processing result image; and
determining pixel points having a value of the set space channel greater than a first set threshold in the first processing result image as first type blemish points, and determining a region defined by the first type blemish points as the first type blemish region.

In an embodiment, adjusting a pixel of the first type blemish region in the original image includes:
adjusting at least one of hue, brightness, and saturation of the first type blemish region in the original image.

In an embodiment, determining the second type blemish region according to the first skin region image and the original image includes:
executing a high pass operation on a set color channel of the first skin region image and the second skin region image, thereby obtaining a second intermediate result image;
executing at least one hard light operation on the second intermediate result image, thereby obtaining a second processing result image; and
determining pixel points having a value of the set color channel less than a second set threshold in the second processing result image as second type blemish points, and determining a region defined by the second type blemish points as the second type blemish region.

In an embodiment, adjusting a pixel of the second type blemish region in the original image includes:
adjusting a color value of the second type blemish region in the original image.

In an embodiment, after obtaining the first skin region image, the method further includes:
perform set filtering on the first skin region image.

What is claimed is:

1. A method of image processing, comprising:
performing skin segmentation on an original image, thereby obtaining a segmentation result image;
fusing the segmentation result image and a standard facial-feature mask image, thereby obtaining a first skin region image;
determining a blemish region according to the first skin region image and the original image; and
adjusting a pixel of the blemish region in the original image, thereby obtaining a target image.

2. The method according to claim 1, wherein fusing the segmentation result image and a standard facial-feature mask image, thereby obtaining a first skin region image comprises:
taking an intersection of the segmentation result image and the standard facial-feature mask image, thereby obtaining the first skin region image.

3. The method according to claim 1, wherein determining a blemish region according to the first skin region image and the original image comprises:
extracting a skin region of the original image, thereby obtaining a second skin region image; and
determining at least one of a first type blemish region and a second type blemish region according to the first skin region image and the second skin region image; and
wherein adjusting a pixel of the blemish region in the original image, thereby obtaining a target image, comprises:
adjusting a pixel of at least one of the first type blemish region and the second type blemish region in the original image, thereby obtaining the target image.

4. The method according to claim 3, wherein determining the first type blemish region according to the first skin region image and the original image comprises:
converting the first skin region image into a first skin color space Lab image;
converting the second skin region image into a second skin Lab image;
executing a high pass operation on a set space channel of the first skin Lab image and the second skin Lab image, thereby obtaining a first intermediate result image;
executing at least one hard light operation on the first intermediate result image, thereby obtaining a first processing result image; and
determining pixel points having a value of the set space channel greater than a first set threshold in the first processing result image as first type blemish points, and determining a region defined by the first type blemish points as the first type blemish region.

5. The method according to claim 4, wherein adjusting a pixel of the first type blemish region in the original image comprises:
adjusting at least one of hue, brightness, and saturation of the first type blemish region in the original image.

6. The method according to claim 3, wherein determining the second type blemish region according to the first skin region image and the original image comprises:
executing a high pass operation on a set color channel of the first skin region image and the second skin region image, thereby obtaining a second intermediate result image;
executing at least one hard light operation on the second intermediate result image, thereby obtaining a second processing result image; and
determining pixel points having a set color channel value less than a second set threshold in the second processing result image as second type blemish points, and determining a region defined by the second type blemish points as the second type blemish region.

7. The method according to claim 6, wherein adjusting a pixel of the second type blemish region in the original image comprises:
adjusting a color value of the second type blemish region in the original image.

8. The method according to claim 1, wherein after the obtaining a first skin region image, the method further comprises:
performing set filtering on the first skin region image.

9-16. (canceled)

17. An electronic device, comprising:
a processing apparatus; and
a memory configured to store a program, wherein
the program, when executed by the processing apparatus, causes the processing apparatus to perform an action comprising:
performing skin segmentation on an original image, thereby obtaining a segmentation result image;
fusing the segmentation result image and a standard facial-feature mask image, thereby obtaining a first skin region image;
determining a blemish region according to the first skin region image and the original image; and
adjusting a pixel of the blemish region in the original image, thereby obtaining a target image.

18. A non-transitory computer-readable storage medium, storing a computer program, wherein the computer program when executed by a processing apparatus, causes the processing apparatus to perform an action comprising:
performing skin segmentation on an original image, thereby obtaining a segmentation result image;
fusing the segmentation result image and a standard facial-feature mask image, thereby obtaining a first skin region image;
determining a blemish region according to the first skin region image and the original image; and
adjusting a pixel of the blemish region in the original image, thereby obtaining a target image.

19. The electronic device according to claim 17, wherein fusing the segmentation result image and a standard facial-feature mask image, thereby obtaining a first skin region image comprises:
taking an intersection of the segmentation result image and the standard facial-feature mask image, thereby obtaining the first skin region image.

20. The electronic device according to claim 17, wherein determining a blemish region according to the first skin region image and the original image comprises:
extracting a skin region of the original image, thereby obtaining a second skin region image; and
determining at least one of a first type blemish region and a second type blemish region according to the first skin region image and the second skin region image; and
wherein adjusting a pixel of the blemish region in the original image, thereby obtaining a target image, comprises:
adjusting a pixel of at least one of the first type blemish region and the second type blemish region in the original image, thereby obtaining the target image.

21. The electronic device according to claim 20, wherein determining the first type blemish region according to the first skin region image and the original image comprises:
converting the first skin region image into a first skin color space Lab image;
converting the second skin region image into a second skin Lab image;
executing a high pass operation on a set space channel of the first skin Lab image and the second skin Lab image, thereby obtaining a first intermediate result image;
executing at least one hard light operation on the first intermediate result image, thereby obtaining a first processing result image; and
determining pixel points having a value of the set space channel greater than a first set threshold in the first processing result image as first type blemish points, and determining a region defined by the first type blemish points as the first type blemish region.

22. The electronic device according to claim 21, wherein adjusting a pixel of the first type blemish region in the original image comprises:
adjusting at least one of hue, brightness, and saturation of the first type blemish region in the original image.

23. The electronic device according to claim 20, wherein determining the second type blemish region according to the first skin region image and the original image comprises:
executing a high pass operation on a set color channel of the first skin region image and the second skin region image, thereby obtaining a second intermediate result image;
executing at least one hard light operation on the second intermediate result image, thereby obtaining a second processing result image; and
determining pixel points having a set color channel value less than a second set threshold in the second processing result image as second type blemish points, and determining a region defined by the second type blemish points as the second type blemish region.

24. The electronic device according to claim 23, wherein adjusting a pixel of the second type blemish region in the original image comprises:
adjusting a color value of the second type blemish region in the original image.

25. The electronic device according to claim 17, wherein after the obtaining a first skin region image, the action further comprises:
performing set filtering on the first skin region image.

26. The non-transitory computer-readable storage medium according to claim 18, wherein fusing the segmentation result image and a standard facial-feature mask image, thereby obtaining a first skin region image comprises:
taking an intersection of the segmentation result image and the standard facial-feature mask image, thereby obtaining the first skin region image.

27. The non-transitory computer-readable storage medium according to claim 18,
wherein determining a blemish region according to the first skin region image and the original image comprises:
extracting a skin region of the original image, thereby obtaining a second skin region image; and
determining at least one of a first type blemish region and a second type blemish region according to the first skin region image and the second skin region image; and
wherein adjusting a pixel of the blemish region in the original image, thereby obtaining a target image, comprises:
adjusting a pixel of at least one of the first type blemish region and the second type blemish region in the original image, thereby obtaining the target image.

28. The non-transitory computer-readable storage medium according to claim 27, wherein determining the first type blemish region according to the first skin region image and the original image comprises:
converting the first skin region image into a first skin color space Lab image;
converting the second skin region image into a second skin Lab image;
executing a high pass operation on a set space channel of the first skin Lab image and the second skin Lab image, thereby obtaining a first intermediate result image;
executing at least one hard light operation on the first intermediate result image, thereby obtaining a first processing result image; and
determining pixel points having a value of the set space channel greater than a first set threshold in the first processing result image as first type blemish points, and determining a region defined by the first type blemish points as the first type blemish region.
